(19) United States
(12) Patent Application Publication
(10) Pub. No.: US 2024/0301997 A1
(43) Pub. Date: Sep. 12, 2024

(54) Tank for a pressurised fluid and associated manufacturing method

(71) Applicant: RAIGI, Rouvray-Saint-Denis (FR)

(72) Inventors: Olivier PERRIER, Neuville Aux Bois (FR); Laure DORIER, Luisant (FR)

(21) Appl. No.: 18/600,368

(22) Filed: Mar. 8, 2024

(30) Foreign Application Priority Data
Mar. 8, 2023 (FR) 2302123

(51) Int. Cl. F17C 1/02; B29C 41/20; B29L 31/00; F17C 1/16

(52) U.S. Cl. CPC F17C 1/02; B29C 41/20; F17C 1/16; B29L 2031/7156; F17C 2203/012; F17C 2203/0604; F17C 2209/2127; F17C 2209/2145

(57) ABSTRACT

This method for fixing a base with at least one element of a liner (24) of a tank (22) for a pressurised fluid comprising a liner (24) in particular comprises forming at least one element of the liner (24) by rotational moulding or by extrusion blow moulding of a polymer on the walls of a mould, the polymer being heated so as to be malleable, and in particular cooling the polymer so as to secure the second portion (40) of the base (34) to the polymer.

### TECHNICAL FIELD

The present invention relates to tanks for transporting pressurised fluid.

In particular, the present invention relates to tanks for pressurised gas of type IV or V, for example dihydrogen, intended to be loaded into vehicles whose fuel comprises dihydrogen.

### PRIOR ART

A tank for gas and/or liquid under pressure generally comprises a main cylindrical shape whose ends are rounded. Such a main shape allows optimisation of the mechanical performance and resistance of the materials of said tank in order to withstand high pressures.

FIG. 1 shows a tank 2 for pressurised fluid according to the state of the art. The tank 2 comprises a liner 4, a base 6 and a reinforcing shell 8 made of composite material.

The liner 4 comprises a cylindrical portion 10 and two domes 12 which are hemispherical, or ellipsoidal or of a similar free shape resulting from a mechanical optimisation calculation at the ends of the cylindrical portion 10. The assembly of the cylindrical portion 10 and the two domes 12 allows the formation of a cavity for transporting the pressurised fluid.

The base 6 is positioned at a longitudinal end of the liner 4, for example in the centre of a dome 12. Optionally, a second base 14 is positioned in the centre of the second dome 12.

The base 6 comprises a first portion 16 forming a longitudinal passage 18 from the inside of the liner 10 towards the outside of the liner 10, and a second portion 20 of transverse dimensions greater than the transverse dimensions of the first portion 16. The second portion 20 is intended to be positioned on the liner 10, for example by gluing on the outer surface of a dome 12 of the liner 10. Alternatively, the dome 12 is overmoulded under the base 6.

The dome 12 on which the base 6 is fixed comprises an opening (not shown) so that the pressurised fluid can circulate from the inside of the cavity to the outside passing through said opening and the passage formed by the first portion 16.

The reinforcement shell 8 is formed around the liner 4 and the second portion 20 of the base 6. Only the first portion 16 of the base 6 protrudes from the reinforcement shell 8 in order to be able to easily fill or empty the tank 2 when the first portion 16 is connected to a connector.

However, this tank 2 has defects due to the fact that the liner 4 can slide with respect to the base 6 at the contact surface between the second portion 20 of the base 6 and the liner 4. The opening of the liner 4 being hidden from the external view by the second portion 20 of the base 6, it is also difficult to control the correct assembly of the tank 2. In addition, particular points P of the tank 2 are subjected to strong mechanical stresses, these points P being in contact with both the base 6, the liner 4 and the reinforcing shell 8 and therefore subject to numerous frictions and mechanical stresses. The pressurised fluid is then capable of escaping or accumulating between the liner 4 and the reinforcing shell 8 and cracking the liner 4.

### DESCRIPTION OF THE INVENTION

The present invention therefore has the purpose of overcoming the aforementioned disadvantages and providing a tank that is simple to assemble, the assembly of which is easily controllable, and the solidity of which at a fluid outlet base is increased. The object of the present invention is a tank for a pressurised fluid comprising a liner forming a cavity intended to contain the pressurised fluid and at least one base, the base comprising a first portion forming a longitudinal passage from the inside of the liner towards the outside of the liner, and a second portion of transverse dimensions greater than the transverse dimensions of the first portion, the second portion of the base being positioned integrally in the cavity formed by the liner, the liner comprising at least one opening of dimensions corresponding substantially to the transverse dimensions of the first portion of the base, the first portion of the base passing through said opening and being intended to accommodate a regulator.

Thus, the base is positioned in such a way as to simplify the assembly and control of the tank. The base also allows to guarantee the good performance and solidity of the tank, the particular points P of the prior art being eliminated, even by making a reinforcing shell over the liner.

In one embodiment, the liner comprises a main tubular portion and two domes which are hemispherical, or ellipsoidal or of a similar free shape resulting from the mechanical optimisation calculation each located at a longitudinal end of the main tubular portion, at least one dome comprising the opening.

Advantageously, the tank comprises a reinforcing shell covering the liner, the reinforcing shell being made of composite material.

In a particular embodiment, the tank comprises a clamping ring positioned around the first portion of the base and intended to clamp the liner between the reinforcing shell and the base.

Advantageously, the first portion of the base and the clamping ring each comprise a thread allowing the positioning and clamping of the clamping ring on the first portion of the base.

In a particular embodiment, the liner is made of a polymer material.

Advantageously, the second portion of the base comprises a mechanical and/or chemical gripping surface intended to be fixed in the material of the liner.

In one embodiment, the base is made of a metal material or a composite material. Advantageously, the tank comprises a second base and a discharge valve, the second base being connected to the discharge valve.

The present invention also relates to a method for fixing the base with at least one element of the liner of the tank as defined previously, the method comprising the following steps:
Fixing the base on an axis driven longitudinally by a cylinder;
Introducing the base into a mould, the dimensions of the mould being adapted to the manufacture of at least one element of the liner comprising the opening;
Closing the mould, the axis being positioned through a slot in the mould intended to form the opening of the liner;
Forming at least one element of the liner by rotational moulding or by extrusion blow moulding of a polymer on the walls of the mould, the polymer being heated so as to be malleable;
Longitudinally moving the base by the cylinder so as to compress the polymer of the liner element between the mould and the second portion of the base, this step of moving the axis being carried out when the polymer is still slightly malleable or sticky;
Cooling the polymer so as to secure the second portion of the base to the polymer. Advantageously, the liner element is a dome which is hemispherical, ellipsoidal or of a similar free shape resulting from the mechanical optimisation calculation.

### BRIEF DESCRIPTION OF THE DRAWINGS

Other purposes, features and advantages of the invention will appear upon reading the following description, given only by way of non-limiting example, and made with reference to the appended drawings wherein:

FIG. 1 is a view of a tank for pressurised fluid according to the prior art;

FIG. 2 is a schematic sectional view of one embodiment of a tank for pressurised fluid according to the invention; and

FIG. 3 is a schematic representation of the steps of an implementation of a method for fixing the base with at least one element of the tank liner according to the invention.

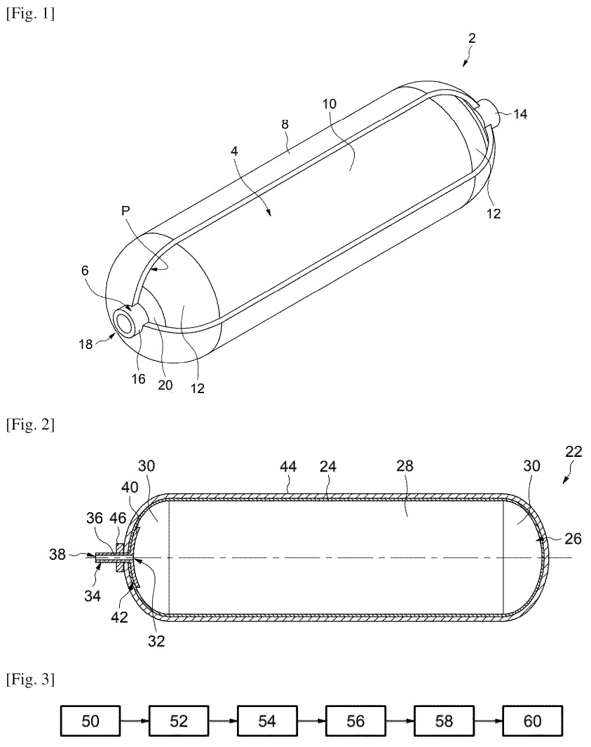

### DETAILED DESCRIPTION OF AT LEAST ONE EMBODIMENT

FIG. 2 schematically shows an embodiment of a tank 22 for a pressurised fluid according to the invention.

The tank 22 comprises a liner 24 forming a cavity 26 intended to contain a pressurised fluid.

The liner 24 preferably comprises a main tubular portion 28 and two domes 30 that are hemispherical, ellipsoidal or of a similar free shape resulting from the mechanical optimisation calculation, each dome 30 being located at a longitudinal end of the main tubular portion 28. The assembly of the main tubular portion 28 with the two domes 30 allows to form the cavity 26. This shape of liner 24 allows optimisation of the mechanical performance and resistance of the liner material so that the liner 24 withstands strong pressures. Other shapes of liner 24 are nevertheless possible.

The material of the liner 24 is for example a polymer, preferably rigid at common temperatures, for example between −40° C. to 85° C.

The liner 24 is for example formed by a rotational moulding method or by extrusion blow moulding. The liner 24 can be formed from a single part or from an assembly of several parts, for example a main tubular portion 28 and two domes 30 assembled by plastic fusion, for example by heat or ultrasound. Rotational moulding is preferred for producing liner 24 having a length greater than or equal to 2 metres, associated with a diameter greater than or equal to 300 millimetres. Alternatively, the extrusion blow moulding may be preferred, particularly for large series manufacturing of more than 10000 parts per year.

The liner 24 further comprises an opening 32 made in its wall so as to be able to fill or empty the contents of the cavity 26. The opening 32 is preferably made in the centre of a dome 30, this arrangement maximising the mechanical resistance of the liner 24. The tank 22 further comprises a base 34 allowing to communicate the cavity 26 with the outside of the tank 22. The base 34 is in particular intended to accommodate a regulator (not shown). The regulator fixed to the base 34 then allows to perform functions of regulating the pressure in the cavity 26 and communicating the fluid to or from the cavity 26.

The base 34 is for example made of a hard material, preferably of a metal or composite material.

The base 34 comprises a first portion 36, which is preferably tubular, forming a longitudinal passage 38 from the cavity 26 towards the outside of the liner 22.

The base 34 also comprises a second portion 40 of transverse dimensions greater than the transverse dimensions of the first portion 36. In particular, the second portion 40 comprises a surface 42 fixed to one end of the first portion 36 so that the base 34 has a “T” shape, the longitudinal passage 38 formed by the first portion 36 also extending longitudinally in the second portion 40.

Advantageously, the base 34 is made in a single-piece. The first portion 36 and the second portion 40 are then manufactured in one piece and integrally, thus allowing to improve the mechanical resistance of said base 34.

The base 34 is fixed to the wall of the liner 24 through the opening 32 of the liner 24 and/or to any other device placed at the end of the passage 38 to fix and guide the base 34 longitudinally.

In particular, the transverse dimensions of the first portion 36 of the base 34 correspond to the dimensions of the opening 32. In other words, when the first portion 36 is tubular, the diameter of the opening 32 corresponds to the external diameter of the first tubular portion 36 so that the first tubular portion 36 is positioned so that the first tubular portion 36 passes through the opening 32.

The second portion 40 of the base 34 is positioned integrally in the cavity 26 formed by the liner 24. In particular, the surface 42 of the second portion 40 on which one end of the first portion 34 is fixed abuts against the wall of the liner 24, preferably completely in abutment.

In a particular embodiment, said surface 42 comprises a mechanical and/or chemical gripping surface intended to be fixed in the material of the liner 24. For example, the mechanical and/or chemical gripping surface 42 comprises interstices wherein the material of the liner can infiltrate during the manufacture of the liner 24 or the dome 30 of the liner 24 by overmoulding on the base 34. Alternatively, the surface 42 is a surface covered with an adhesion primer or with a layer of a polymer that can fuse with the polymer of the liner. In a second variant, the surface 42 is produced by mechanical sandblasting. The mechanical gripping surface 42 thus guarantees a solid base-liner connection.

Moreover and regardless of the embodiment, when the liner 24 comprises a pressurised fluid, the fluid exerts pressure on the base 34, the second portion 40 of which bears on the wall of the liner 24, the first portion 36 of the base 34 preventing excessive transverse sliding of the base 34.

Preferably, the tank 22 further comprises a reinforcing shell 44 externally covering the liner 24. The reinforcing shell 44 is for example made of composite material. The reinforcing shell 44 allows to protect the liner from the external environment and also allows to stiffen the tank 22 so as to reinforce the mechanical resistance of the liner 24 when the liner 24 is subjected to high pressures from the pressurised fluid contained in the cavity 26.

The reinforcing shell 44 is for example produced by winding a composite material around the liner 24, leaving an exit space for the first portion 36 of the base 34.

The presence of the liner 24 between the second portion 40 of the base 34 and the reinforcing shell 44 has in particular the advantage of less weakening the area of the tank 22 around the base 34.

Optionally, the tank 22 comprises a clamping ring 46 positioned around the first portion 36 of the base 34 and intended to exert longitudinal clamping of the liner 24 between the reinforcing shell 44 and the base 34. In other words, the clamping ring 46 performs longitudinal compression of the liner 24 between the reinforcing shell 44 and the base 34.

Indeed, the area close to the base 34 is the most fragile area of the tank 22. The clamping ring 46 allows in particular to reinforce this area and to avoid fluid leaks as well as to reinforce the impact resistance of the tank 22.

The clamping ring 46 is for example made of metal material or of a composite material. In a particular embodiment, the first portion 36 of the base 34 comprises an external thread (not shown) and the clamping ring 46 comprises an internal thread (not shown) allowing the positioning, fixing and clamping of the clamping ring 46 around the first portion 36 of the base 34 and compressing the reinforcing shell 44 towards the liner 24 and the second portion 40 of the base 34.

Optionally, the clamping ring 46 comprises a fixing support (not shown) for fixing the tank 22 to the chassis of a vehicle transporting said tank 22.

In a variant, the tank 22 comprises a second base (not shown). The second base is for example fixed opposite the first base 34 described previously and is similar to the base 34. Each of the two bases 34 is for example positioned in the centre of a dome 30 through an opening 32. The second base can be useful in the use of large tanks, for example of a length greater than or equal to 2 metres and a diameter of 300 millimetres.

Advantageously, the tank 22 comprises a first discharge valve connected to a temperature probe and fixed to the base 34, as well as a second discharge valve connected to a temperature probe and fixed to the second base, the discharge valves then having the function of evacuating the gas contained in the tank in the event of fire and of rapidly dropping its pressure. Alternatively, a single discharge valve is fixed to the base 34 when there is only one base 34, for example for a tank 22 of length less than 800 mm and diameter comprised between 150 and 400 millimetres.

The different steps of a method for fixing the base 34 with at least one element of the liner 24 were schematically shown in FIG. 3. In particular, the element of the liner 24 can be the entire liner 24 or a portion comprising an opening 32, for example a dome 30 which is hemispherical, ellipsoidal or of a similar free shape resulting from the mechanical optimisation calculation.

Obviously, the method illustrated in FIG. 3 is a method for manufacturing a tank as described previously.

Optionally, prior to the implementation of this method, the base 34 is treated at the surface 42 to facilitate adhesion between the base 34 and the internal wall of the liner 24. This treatment can be a mechanical sandblasting and/or a treatment of chemical deposition in one or two layers of an adhesion primer and/or a layer of polymer capable of fusing with the polymer of the liner. This primer and/or this polymer are also called chemical treatment.

To implement this method, a step 50 of fixing the base 34 on an axis whose longitudinal movement is driven by a cylinder is first carried out. For example, the first portion 36 of the base 34 is fixed to the axis.

Then, the base is introduced into a mould during a step 52, the dimensions of said mould corresponding to the dimensions of the element of the liner 24 to be manufactured, the mould comprising a slot intended to form the opening 32 of the liner 24. Alternatively, the axis can be introduced into the mould through a slot in the mould intended to form the opening 32 of the liner 24, then the base 34 can be fixed to the axis by opening the mould.

Then, a step 54 of closing the mould is carried out. At the end of this step 54, the mould of the liner 24 or a dome 30 is closed and the axis is positioned through the slot.

Step 56 of forming the liner element 24 is then carried out by rotational moulding or by extrusion blow moulding of a polymer onto the walls of the mould, the polymer being heated beforehand so as to be malleable, for example at a temperature greater than 150° depending on the type of material and the method.

According to certain variants of the method used and its degree of automation, the material intended to form the liner 24 is introduced in different forms and at different steps.

In rotational moulding, the material will for example be introduced manually and in parallel with step 52.

In rotational moulding with an automatic material introduction system, the material of the liner 24 will be introduced parallel to step 52 or parallel to step 56, the material then being introduced through a cavity provided for this purpose into the mould which will then be automatically closed.

In extrusion blow moulding, a parison of hot material intended to form the liner 24 comes down vertically from an extrusion screw into the mould of the liner 24 and will slide surrounding the base 34, for example in parallel to step 52. In this implementation, a single base 34 is present while rotational moulding allows the presence of two bases 34. The blowing of air or a gas into the parison is carried out through the passage 38.

In extrusion blow moulding, closing the mould in step 54 causes the parison to shrink so that the liner 24 fits around the first portion 36 of the base 34.

When the polymer is still malleable or sticky, in other words when it is still in the tacking phase before its complete cooling, a step 58 of longitudinally moving the base 34 is carried out using the cylinder so as to compress the polymer of the liner element 24 between the mould and the second portion 40 of the base 34. This amounts to carrying out a step of overmoulding the liner 24 against the second portion 40 of the base 34, in particular against the mechanical gripping surface 42.

When a chemical treatment is given to the surface 42 of the base, the base 34 is ideally heated by means of electrical resistances, ultraviolet or infrared ray lamps, so as to facilitate the fusion between the liner 24 and the base 34. This heating is carried out during or before the steps of the method described above. Thus, the chemical treatment at the surface 42 is thus kept malleable and/or sticky, so as to carry out fusion welding between the chemical treatment of the surface 42 and the polymer of the liner 24. Finally, a step 60 of cooling the polymer and the base is carried out so as to secure the second portion 40 of the base 34 with the liner element 24. The base 34 is then caught into the polymer. The fixing of the base 34 on the axis can also be removed.

For the manufacture of the complete tank 22, it is possible to surround the liner 24 assembled by a composite material so as to form the reinforcing shell 44 and leaving the first portion 36 of the base 34 free for an optional clamping ring 46.

1. A method for fixing a base with at least one element of a liner of a tank or a pressurised fluid comprising said liner forming a cavity intended to contain the pressurised fluid and at least one base, the base comprising a first portion forming a longitudinal passage from the inside of the liner towards the outside of the liner, and a second portion of transverse dimensions greater than the transverse dimensions of the first portion, the second portion of the base being positioned integrally in the cavity formed by the liner, the liner comprising at least one opening of dimensions corresponding substantially to the transverse dimensions of the first portion of the base, the first portion of the base passing through said opening and being intended to accommodate a regulator, characterised in that it comprises the following steps:
Fixing the base on an axis driven longitudinally by a cylinder;
Introducing the base into a mould, the dimensions of the mould being adapted to the manufacture of at least one element of the liner comprising the opening;
Closing the mould, the axis being positioned through a slot in the mould intended to form the opening of the liner;
Forming at least one element of the liner by rotational moulding or by extrusion blow moulding of a polymer onto the walls of the mould, the polymer being heated so as to be malleable;
Longitudinally moving the base by the cylinder so as to compress the polymer of the liner element between the mould and the second portion of the base, this step of moving the axis being carried out when the polymer is still slightly malleable or sticky;
Cooling the polymer so as to secure the second portion of the base to the polymer.

2. The method according to claim 1, wherein the liner of the tank comprises a main tubular portion and two domes which are hemispherical, or ellipsoidal or of a similar free shape resulting from the mechanical optimisation calculation each located at a longitudinal end of the main tubular portion, at least one dome comprising the opening.

3. The method according to claim 2, wherein the tank comprises a reinforcing shell covering the liner, the reinforcing shell being made of composite material.

4. The method according to claim 3, wherein the tank comprises a clamping ring positioned around the first portion of the base and intended to clamp the liner between the reinforcing shell and the base.

5. The method according to claim 4, wherein the first portion of the base and the clamping ring each comprise a thread allowing the positioning and clamping of the clamping ring on the first portion of the base.

6. The method according to claim 5, wherein the liner is made of a polymer material.

7. The method according to claim 6, wherein the second portion of the base comprises a mechanical and/or chemical gripping surface intended to be fixed in the material of the liner.

8. The method according to claim 7, wherein the base is made of a metal material or a composite material.

9. The method according to claim 8, wherein the tank comprises a second base and a discharge valve, the second base being connected to the discharge valve.
